(19) United States
(12) Patent Application Publication
(10) Pub. No.: US 2024/0386631 A1
(43) Pub. Date: Nov. 21, 2024

(54) GRAPHICAL USER INTERFACE FOR VISUALIZATION IN A SUPPLY CHAIN NETWORK

(71) Applicant: Kinaxis Inc., Ottawa (CA)

(72) Inventors: Elias Garcia CASTRO, La Paz (MX); Oscar Erik Perez GONZALEZ, Zapopan (MX)

(21) Appl. No.: 18/656,905

(22) Filed: May 7, 2024

Related U.S. Application Data
(60) Provisional application No. 63/502,199, filed on May 15, 2023.

(51) Int. Cl. G06T 11/20; G06Q 10/0835

(52) U.S. Cl. CPC G06T 11/206; G06Q 10/0835

(57) ABSTRACT

A graphical user interface for visualization that comprises a timeline library which can be customized to render supply and demand data as points in the timeline visualization. The timeline visualization represents a demand as a first icon and a supply as a second icon. A software language class can be customized to correctly connect the supply icons that represent stock transfer movements between a source and destination site with an arrow, as well as, to allow a user to drag the arrow to another supply point.

This application claims priority from U.S. Provisional Ser. No. 63/502,199, filed May 15, 2023, which is incorporated by reference in its entirety herein.

### BACKGROUND

When dealing with a distribution network where stock is moved between sites by planners, in order to ensure the fulfillment of demands and a certain service level via inventory levels, it is necessary to provide such planners the ability to visualize clearly and efficiently the stock movements between sites and to give these planners the ability to manually modify the (allocation) movement of stock.

### BRIEF SUMMARY

Disclosed herein is a graphical user interface to visualize supply transfers between sites/silos in a supply chain network. The graphical user interface can provide details of quantity and date and it can also show source and destination data (site and date).

The graphical user interface can include a chart that can be based on timelines which can include the following elements: supplies, demands and the balance of inventory at such sites/silos, shown through a time horizon. Additionally, as a feature of the chart, it is possible to manually alter the destination of a supply transfer by moving an icon that graphically represents the supply transfer.

In one aspect, a computer-implemented method is provided which includes: reading, by a processor, data from a worksheet via a visualization software development kit; transforming, by the processor, the data for consumption by a timeline visualization library; rendering, by the processor, the data as points in a timeline visualization chart that is displayed on a graphical user interface; representing, by the processor, a first subset of data points by a first icon and a second subset of data points by a second icon; and representing, by the processor, one or more transfers of material goods from one or more members of the first subset of data points to a respective one or more members of the second subset of data points via one or more classes of a software language.

The computer-implemented method may also further include: overriding, by a user, one or more of the one or more transfers of material goods. The user may override at least one of a destination and a date.

In the computer-implemented method, the software language can be JavaScript. Other technical features may be readily apparent to one skilled in the art from the following figures, descriptions, and claims.

In one aspect, a system is provided, which includes a processor, a memory storing instructions that, when executed by the processor, configure the system to: read, by the processor, data from a worksheet via a visualization software development kit; transform, by the processor, the data for consumption by a timeline visualization library; render, by the processor, the data as points in a timeline visualization chart that is displayed on a graphical user interface; represent, by the processor, a first subset of data points by a first icon and a second subset of data points by a second icon; and represent, by the processor, one or more transfers of material goods from one or more members of the first subset of data points to a respective one or more members of the second subset of data points via one or more classes of a software language.

The system may also include instructions that further configure the system to override, by a user, one or more of the one or more transfers of material goods. The user may override at least one of a destination and a date. In the system, the software language can be JavaScript. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: read, by a processor, data from a worksheet via a visualization software development kit; transform, by the processor, the data for consumption by a timeline visualization library; render, by the processor, the data as points in a timeline visualization chart that is displayed on a graphical user interface; represent, by the processor, a first subset of data points by a first icon and a second subset of data points by a second icon; and represent by the processor, one or more transfers of material goods from one or more members of the first subset of data points to a respective one or more members of the second subset of data points via one or more classes of a software language.

The computer-readable storage medium may also include instructions that further configure the computer to override, by a user, one or more of the one or more transfers of material goods. The user may override at least one of a destination and a date. In the computer-readable storage medium, the software language can be JavaScript.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for a graphical user interface to visualize supply transfers between sites/silos in a supply chain network, in accordance with one embodiment.

FIG. 2 illustrates a block diagram in accordance with one embodiment.

FIG. 3 illustrates a graphical user interface showing a timeline in accordance with one embodiment.

FIG. 4 illustrates a focus on supply transfers from one of the supply sources shown in the graphical user interface in FIG. 3.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

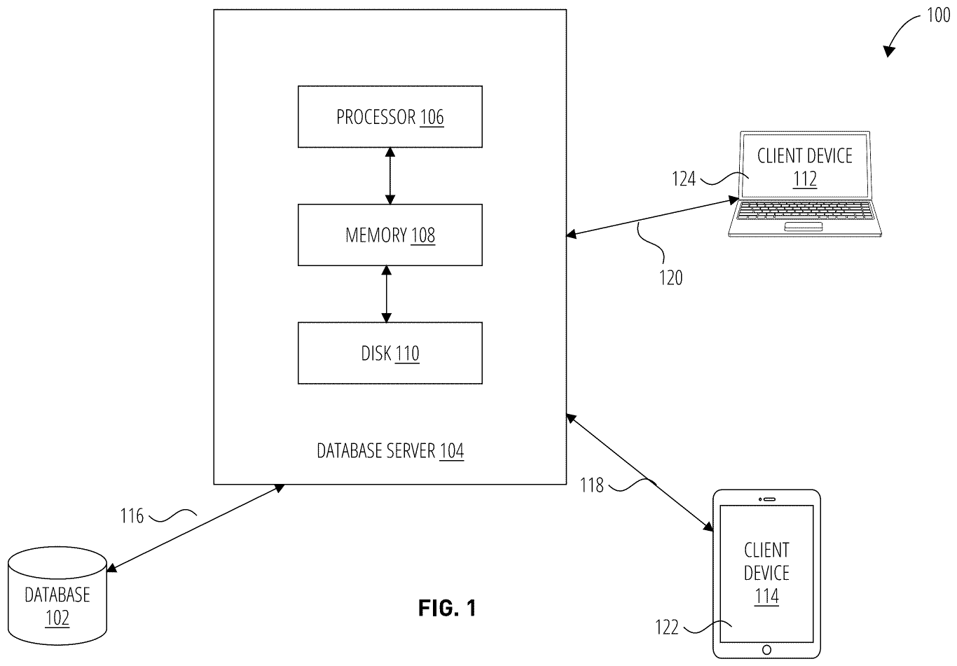

FIG. 1 illustrates an example of a system 100 for a graphical user interface for visualization in a supply chain network.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

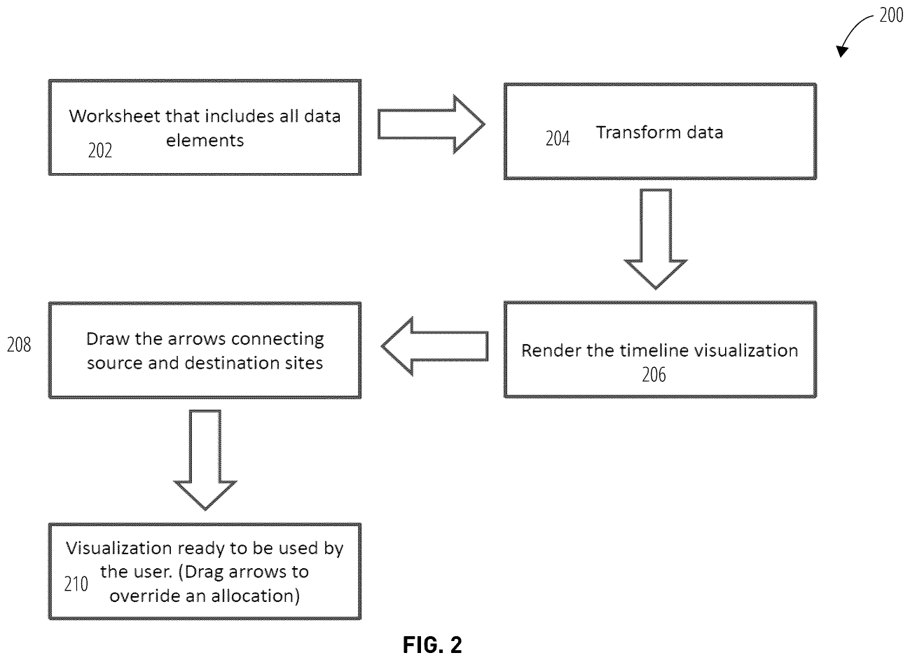

FIG. 2 illustrates a block diagram 200 in accordance with one embodiment.

A graphical user interface for visualization in a supply chain network, can comprise the following:
1) A worksheet that contains all data elements. For example, a list of supplies with their respective quantity and date attributes, as well as an inventory balance at each site.
2) A visualization SDK (software development kit).
3) A custom timeline visualization open source library (for example, vis.js community edition).
4) A custom open source JavaScript class to draw lines to connect items in a timeline visualization (for example, timeline arrows).

The graphical user interface reads the data from a worksheet via the visualization SDK. It then transforms the data in order to be consumed by the timeline visualization library. The timeline library can be customized to render the supply and demand data as points in the timeline visualization chart, representing a demand as a first icon (for example, a downward-facing triangle) and a supply as a second icon (for example, an upward-facing triangle). The JavaScript class can be customized to correctly connect the supply icons that represent stock transfer movements between a source and destination site with an arrow, as well as, to allow a user to drag the arrow to another supply point and date.

As shown in FIG. 2, at 202, a worksheet includes all data elements of the supply chain. At 204, the data is transformed, followed by rendering the timeline visualization at 206. At 208, arrows are used to connect source and destination sites. Then, at 210, the visualization is ready to be used by a user, who can, for example, drag one or more arrows to override the mentioned transfers of material goods.

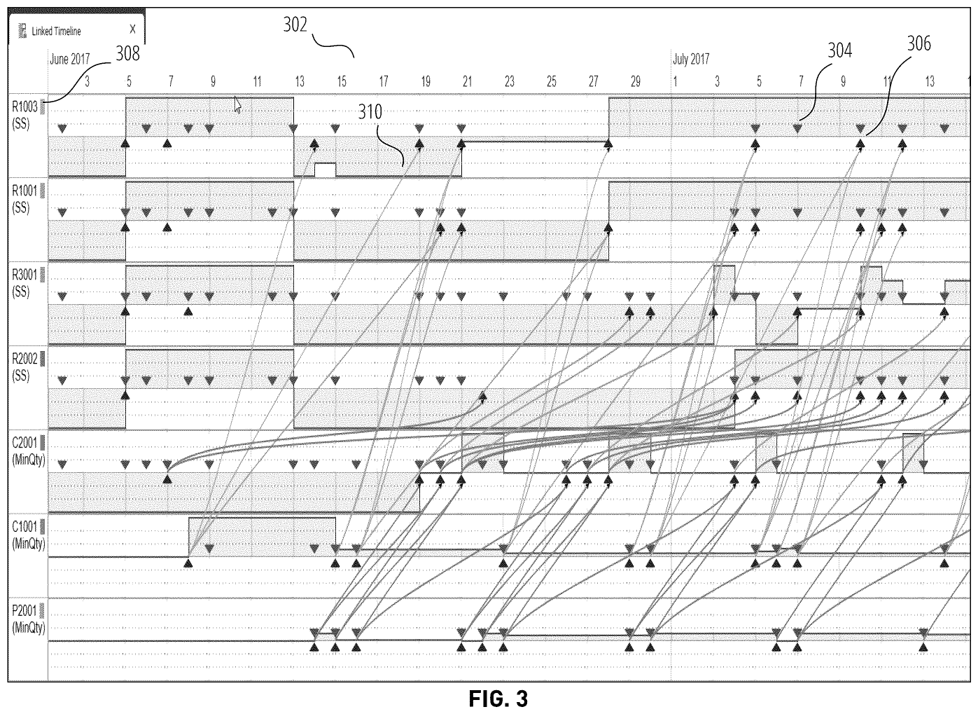

FIG. 3 illustrates a graphical user interface showing a timeline 302 in accordance with one embodiment. The timeline indicates Demands 304 represented by triangles pointing downward, while Supplies 306 are represented as triangles pointing upward. Each receiving site (i.e. a site that receives supplies) is associated with a respective colour code block. For example, receiving site R1003 is associated with colour code block 308. Similarly, receiving sites R1001, R3001, R2002 and C2001 each have an associated respective colour code block. These colour code blocks look similar in FIG. 3, due to the gray-scale nature of the Figure; however, in the actual embodiment of the graphical user interface, the colour code blocks each have a distinct colour which is distinguishable.

A supply transfer (from a supply silo to a receiving site) is shown as a line ending at an upright arrow (at the receiving site), between a silo and receiving site. In the actual graphical user interface, the line has a colour that corresponds to the colour block of the receiving site, for easier identification. For example, a supply transfer from supply silo C1001 to receiving site R1003 is represented by line 310. The supply leave C1001 on Jun. 8, 2017 and arrives at R1003 on Jun. 19, 2017.

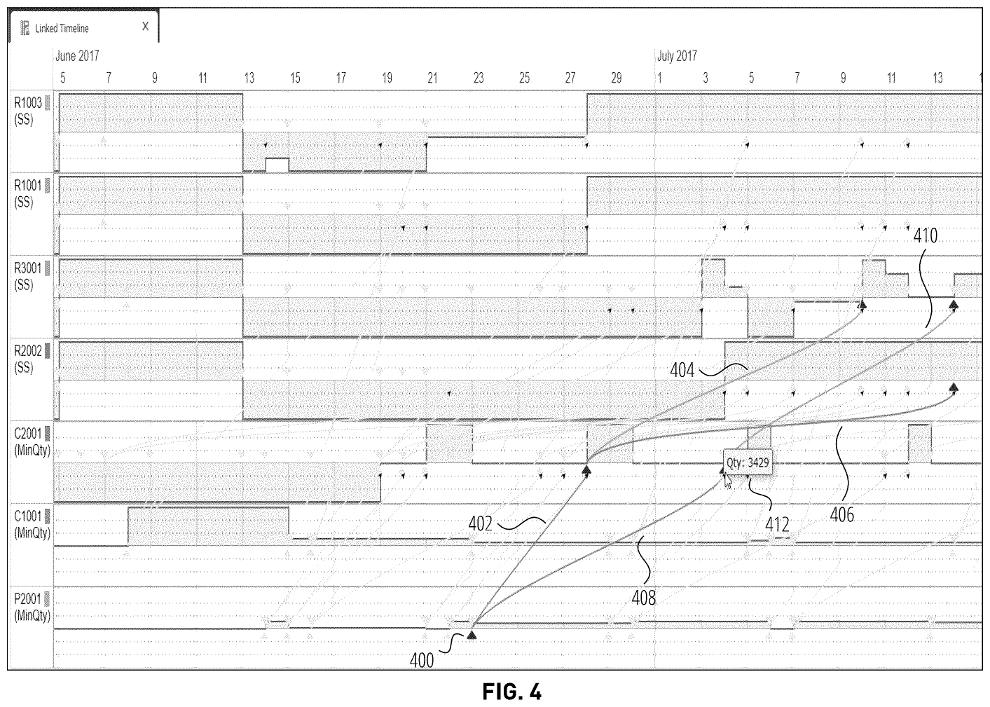

FIG. 4 illustrates a focus on supply transfers from one of the supply sources shown in the graphical user interface in FIG. 3. That is, the graphical user interface has an ability to focus on one supply source, along with the receiving sites where the supply (from the supply source) is transferred.

In FIG. 4, the supply source of focus is P2001, and the supply transfers originating on Jun. 23, 2017 (represented by upward-pointing triangle 400) are shown. The graphical user interface has an ability to focus on supplies sent from a supply source, and track the shipment of those supplies, as described below.

A first portion of the supply at 400 is transferred to C2001 (as shown by line 402), arriving at receiving site C2001 on Jun. 28 (2017). However, the supplies transferred to C2001, as depicted by line 402, do not remain at C2001. Instead, C2001 then serves as a supply site, by transferring two portions on the day it received the supply from P2001, namely Jun. 28, 2017. A first portion, depicted by line 404, arrives at receiving site R3001 on Jul. 9, 2017. A second portion, depicted by line 406, arrives at receiving site R2002 on Jul. 14, 2017.

A second portion of the supply at 400 is transferred from P2001 on Jun. 23, 2017 to C2001 (as shown by line 408). The supply transfer 408 arrives at receiving site C2001 on Jul. 3, (2017). However, the supplies transferred to C2001, as depicted by line 408, do not remain at C2001. Instead, C2001 then serves as a supply site, by transferring a portion on the day it received the supply from P2001, namely Jul. 3, 2017. That supply transfer, depicted by 410, arrives at receiving site R3001 on Jul. 14, 2017. The quantity shown as a tooltip 412, is the total quantity received on Jul. 3, 2017 at the receiving site C2001.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
reading, by a processor, data from a worksheet via a visualization software development kit;
transforming, by the processor, the data for consumption by a timeline visualization library;
rendering, by the processor, the data as points in a timeline visualization chart that is displayed on a graphical user interface;
representing, by the processor, a first subset of data points by a first icon and a second subset of data points by a second icon; and
representing, by the processor, one or more transfers of material goods from one or more members of the first subset of data points to a respective one or more members of the second subset of data points via one or more classes of a software language.

2. The computer-implemented method of claim 1, further comprising:
overriding, by a user, one or more of the one or more transfers of material goods.

3. The computer-implemented method of claim 2, wherein the user overrides at least one of a destination and a date.

4. The computer-implemented method of claim 1, wherein the software language is JavaScript.

5. A system comprising:
a processor; and
a memory storing instructions that, when executed by the processor, configure the system to:
read, by the processor, data from a worksheet via a visualization software development kit;
transform, by the processor, the data for consumption by a timeline visualization library;
render, by the processor, the data as points in a timeline visualization chart that is displayed on a graphical user interface;
represent, by the processor, a first subset of data points by a first icon and a second subset of data points by a second icon; and
represent, by the processor, one or more transfers of material goods from one or more members of the first subset of data points to a respective one or more members of the second subset of data points via one or more classes of a software language.

6. The system of claim 5, wherein the instructions further configure the system to:
override, by a user, one or more of the one or more transfers of material goods.

7. The system of claim 6, wherein the user overrides at least one of a destination and a date.

8. The system of claim 5, wherein the software language is JavaScript.

9. A non-transitory computer-readable storage medium, the computer-readable storage medium including instructions that when executed by a computer, cause the computer to:
read, by a processor, data from a worksheet via a visualization software development kit;
transform, by the processor, the data for consumption by a timeline visualization library;
render, by the processor, the data as points in a timeline visualization chart that is displayed on a graphical user interface;
represent, by the processor, a first subset of data points by a first icon and a second subset of data points by a second icon; and
represent by the processor, one or more transfers of material goods from one or more members of the first subset of data points to a respective one or more members of the second subset of data points via one or more classes of a software language.

10. The computer-readable storage medium of claim 9, wherein the instructions further configure the computer to:
override, by a user, one or more of the one or more transfers of material goods.

11. The computer-readable storage medium of claim 10, wherein the user overrides at least one of a destination and a date.

12. The computer-readable storage medium of claim 9, wherein the software language is JavaScript.
